(19) United States
(12) Patent Application Publication
(10) Pub. No.: US 2007/0204703 A1
(43) Pub. Date: Sep. 6, 2007

(54) Material for magneto-elastic transducer

(75) Inventor: David W. Cripe, Chatham, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/368,570

(22) Filed: Mar. 6, 2006

(51) Int. Cl. G01L 3/00

(52) U.S. Cl. 73/862.08

(57) ABSTRACT

A non-contact torque sensor assembly includes a torque transducer fabricated from a material that provides a high level of output in response to the shear stresses generated by the applied torque. The torque transducer is heat treated and cold worked to instill the desired magnetic anisotropy. The example torque transducer is fabricated from a steel alloy including between 17 and 35% chromium, 5 to 20% cobalt and the remainder iron.

### BACKGROUND OF THE INVENTION

This invention generally relates to non-contact force sensor. More particularly, this invention relates to a torque transducer for a torque sensor.

A non-contact torque transducer utilizes an Inverse-Wiedemann effect in ferromagnetic material in which stresses from an applied torque cause a shift in an intrinsic circumferentially orientated magnetic field. The shift in the magnetic field is proportional to the applied force and is measured to determine the magnitude of applied torque.

The material utilized for the transducer is endowed with different magnetic properties in different directions. This magnetic anisotropy includes a coercive force in an axial direction that exceeds the magnetic field emitted by the transducer at a maximum applied torque. It is further desired that the material have a small hysteresis in view of the dynamic range of the transducer.

A torque transducer can either include a collar or be collarless. A collarless transducer includes only a shaft that is exposed to the torque. The collarless torque transducer requires a high magnetic remanence value to provide the desired high magnetic field output-per-unit of shear stress. The yield stress should also be compatible with the application, so that it is not necessary to affect the diameter of the transducer to reduce shear stress relative to the materials to which it is mated.

A torque transducer utilizing a collar is generally capable of generating a high magnetic field per applied unit stress and low hysteresis, but is often required to be modified to obtain the desired magnetic anisotropy that produces the desired magnetic hysteresis properties.

Accordingly, it is desirable to design and develop a torque transducer fabricated from a material that provides the desired magnetic properties along with the required mechanical properties to produce a high-output-per shear stress unit without a collar.

### SUMMARY OF THE INVENTION

An example non-contact torque sensor assembly includes a torque transducer fabricated from a material that provides a high level of output in response to the shear stresses generated by the applied torque. The torque transducer is heat treated and cold worked to instill the desired magnetic anisotropy.

The example torque transducer is fabricated from a steel alloy including between 17 and 35% chromium, 5 to 20% cobalt and the remainder iron. The torque transducer 12 is then solution annealed and rapidly quenched to a substantially ambient temperature. The heat treated torque transducer is then instilled with a desired magnetic field anisotropy that is induced by cold working the torque transducer.

After cold working of the torque transducer a second heat treating process is initiated. The second heat treat process includes heating the torque transducer to a temperature greater than the temperature at which the material losses any permanent magnetism known as a materials Curie temperature. The torque transducer is soaked for a desired time at the Curie temperature than cooled at a controlled rate.

During the controlled cooling of the torque transducer, a further magnetic anisotropy defining process may be performed that includes passing a current through a conductor concentrically disposed about the torque transducer. The current is of an amplitude and frequency that is determined to induce a magnetic field in the torque transducer that exceeds the materials coercive force.

A torque transducer fabricated utilizing the inventive alloy and fabrication method can attain a remnant magnetic flux of over 9000 Gauss, and coercive forces of between 300 and 500 Oersteads. Conventionally fabricated torque transducers provide remnant magnetic flux of only about 3000 Gauss and coercive forces of only about 50 Oersteads with heat treated SAE 4340 material.

These and other features of the present invention can be best understood from the following specification and drawings, the following of which is a brief description.

### BRIEF DESCRIPTION OF THE DRAWINGS

FIG. 1 is a schematic representation of an example torque sensor assembly according to this invention.

FIG. 2 is a schematic representation of an example method of fabricating a torque sensor according to this invention.

### DETAILED DESCRIPTION OF THE PREFERRED EMBODIMENT

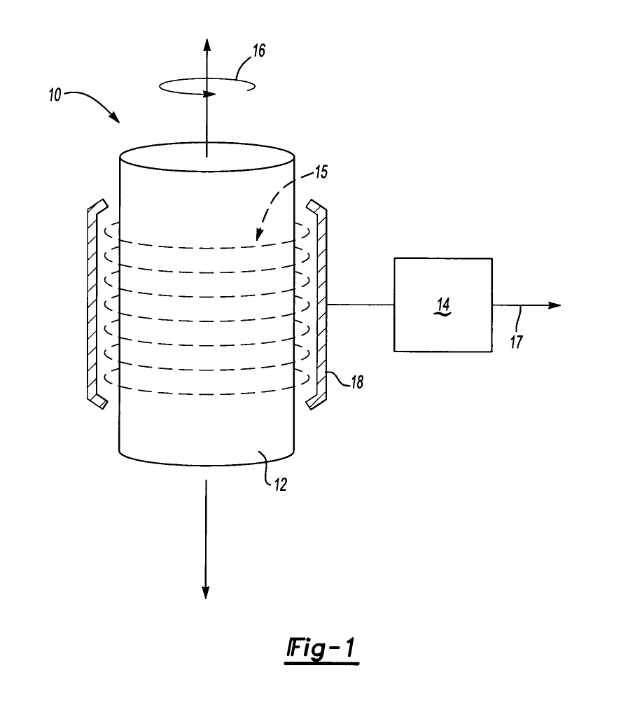

Referring to FIG. 1 a non-contact torque sensor assembly 10 includes a torque transducer 12 that produces a magnetic field 15 responsive to the application of a torque 16. The torque 16 changes an orientation of the magnetic field 15 that is sensed by a magnetic field sensor 18. The changes detected by the magnetic field sensor 18 are communicated to a magnetometer circuit 14. The magnetometer circuit 14 transforms the signal from the magnetic field sensor 18 into an output 17 indicative of the applied torque 16 that is utilized by a system, such as for example a steering system.

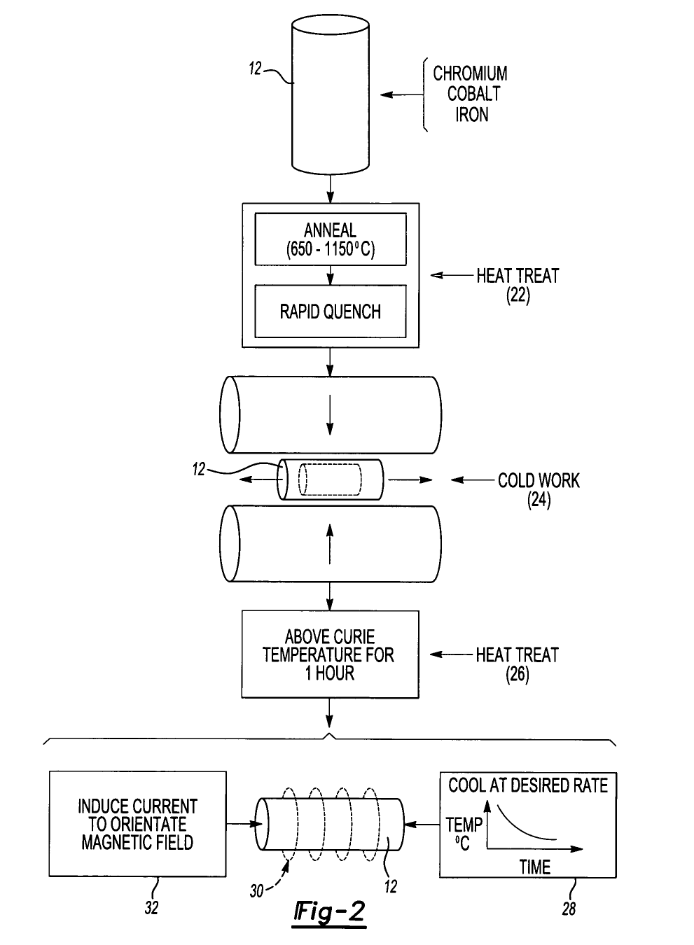

Referring to FIG. 2, the torque transducer 12 is fabricated from a material that provides a high level of output in response to the shear stresses generated by the applied torque 16. The material is a steel alloy including between 17 and 35% chromium, 5 to 20% cobalt and the remainder iron. The torque transducer 12 is either cast or machined to the desire shape using known methods. The torque transducer 12 may also include 0.1 to 5% of one or more materials selected from the group of Boron (B), Silicon (Si), Aluminum (Al), Molybdenum (Mo), Tungsten (W), Manganese (Mn), Titanium (Ti), Niobium (Nb), Zirconium (Zr), Tin (Sn), and Zinc (Zn). The addition of these elements to the alloy provides for increased yield strength and better magnetic performance.

The material composition of the torque transducer 12 provides the foundation for a low hysteresis and a high magnetic field output-per-unit of shear stress. The high output improves accuracy and durability of the torque transducer 12. The torque transducer 12 is then solution annealed at a temperature of between 650 and 1150° C. as is indicated at 22. From the heated temperature the torque transducer 12 is rapid quenched to a substantially ambient temperature.

The heat treated torque transducer 12 is then instilled with a desired magnetic field orientation or anisotropy. The desired magnetic anisotropy is induced by cold working the torque transducer 12. Cold working includes methods such as stretching, compressing and rolling to reduce one dimension and increase another dimension. The example torque transducer 12 is cold worked by rolling as indicated at 24. The torque transducer 12 is rolled between two hardened rollers to decrease a diameter while increasing a length of the torque transducer 12. The cold work rolling process elongates the torque transducer 12. The cold working process increases magnetic remanence in the direction of elongation. The cold working process also increases magnetic coercivity in a direction orthogonal to the direction of elongation. Coercivity is the intensity of the magnetic field needed to reduce the magnetization of a ferromagnetic material to zero after it has reached saturation.

After cold working of the torque transducer 12 a second heat treating process is initiated. The second heat treat process includes heating the torque transducer 12 to a temperature greater than the temperature at which the material losses any permanent magnetism known as a materials Curie temperature. The Curie temperature for the inventive material is nominally 700° C. The torque transducer is soaked at the Curie temperature for one hour and then cooled at a desired rate as indicated at 28.

The fixed rate of the controlled cooling process is determined to maintain and instill desired magnetic and mechanical properties within the torque transducer. For this inventive method, the torque transducer is cooled at nominally 50° C. per hour until the material temperature is no greater than 480° C. The torque transducer is then cooled normally back to ambient conditions.

During the controlled cooling of the torque transducer 12, a further magnetic anisotropy defining process may be performed that includes passing a current through a conductor 30 concentrically disposed about the torque transducer 12 as is indicated at 32. The current includes an amplitude and frequency that is determined to induce a magnetic field in the torque transducer that exceeds the materials coercive force. The coercive force of the torque transducer is that force that produces a slowness or difficulty in imparting magnetism and is further, that force that creates an obstacle to the return to its natural state when active magnetism has ceased. The coercive force is dependent on the specific material composition of the torque transducer. The current is applied throughout the controlled cooling process.

A torque transducer fabricated utilizing the inventive alloy and method can attain a remnant magnetic flux of over 9000 Gauss, and coercive forces of between 300 and 500 Oersteads. Compared to prior art torque transducers that provide a remnant magnetic flux of only about 3000 Gauss and coercive forces of only about 50 Oersteads with a heat treated SAE 4340 material. The performance of the Iron, Chromium, and cobalt torque transducer is generally the same as is provided with a ring type torque transducer without the required additional stress anisotropy required of the ring type transducer.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A torque sensor assembly comprising:
a torque transducer fabricated from an alloy containing between 17 and 35% chromium, 5-20% cobalt and a remainder iron.

2. The assembly as recited in claim 1, wherein the torque transducer is cold worked to approximate the final desired shape.

3. The assembly as recited in claim 2, wherein the torque transducer is cold worked to reduce a material dimension by up to 50% to introduce a desired magnetic anisotropy.

4. The assembly as recited in claim 3, wherein the torque transducer is heat treated above the Curie temperature.

5. The assembly as recited in claim 4 wherein the torque transducer is maintained above the Curie temperature for one hour.

6. The assembly as recited in claim 4, wherein the heat treating is followed by cooling at a desired rate.

7. The assembly as recited in claim 6, wherein the desired rate of cooling comprises cooling at nominal 50° C. per hour to a temperature no greater than 480° C.

8. The assembly as recited in claim 7, wherein the torque transducer is produced by inducing a desired magnetic field orientation by passing a current through the transducer.

9. The assembly as recited in claim 8, wherein the magnetic field produced by the current is of an amplitude that exceeds a coercive force of the torque transducer.

10. The assembly as recited in claim 9, wherein the current is applied during cooling from the Curie temperature to the temperature no greater than 480° C.

11. The assembly as recited in claim 1, wherein the torque transducer includes 0.1 to 5% of a metal selected from the group consisting of B, Si, Al, Mo, W, Mn, Ti, V, Nb, Zr, Sn, and or Zn.

12. The method of fabricating a torque transducer assembly comprising the steps of:
a) fabricating a torque transducer from a metal comprising 17 to 35% chromium, 5-20% cobalt, and iron into a desired shape;
b) annealing the torque transducer at between 650° C. and 1150° C. followed by a rapid quenching;
c) cold working the torque transducer to instill a desired magnetic anisotropy;
d) heat treating the torque transducer by heating the torque transducer to a temperature above a Curie temperature of the material; and
e) cooling the torque transducer at a desired rate to a nominal temperature of no greater than 480° C.

13. The method as recited in claim 12, wherein the desired cooling rate comprises 50° C. per hour.

14. The method as recited in claim 12, wherein the torque transducer further comprises 0.1 to 5% of a material selected from a group consisting of B, Si, Al, Mo, W, Mn, Ti, V, Nb, Zr, Sn, and Zn.

15. The method as recited in claim 12, including the step of inducing a magnetic field in a desired orientation by passing a current through a conductor concentric with the transducer.

16. The method as recited in claim 15, wherein the current includes an amplitude that exceeds a coercive force of the torque transducer material.

17. The method as recited in claim 15, wherein the current is applied to the torque transducer during step e.
